(19) United States
(12) Patent Application Publication
(10) Pub. No.: US 2004/0024281 A1
(43) Pub. Date: Feb. 5, 2004

(54) Method for stabilization of material or waste to reduce metals and fluoride leaching potential

(76) Inventor: Keith Edward Forrester, Meredith, NH (US)

Correspondence Address: KEITH FORRESTER, 78 TRACY WAY, MEREDITH, NH, 03253, US

(21) Appl. No.: 10/212,025

(22) Filed: Aug. 5, 2002

(51) Int. Cl. A62D 3/00

(52) U.S. Cl. 588/256

(57) ABSTRACT

This invention provides a method for chemical stabilization of heavy metal bearing materials and wastes while minimizing fluoride solubility subject to acid and water leaching tests or leach conditions by addition of stabilizing agents such that the leaching potential is inhibited to desired levels. The resultant material or waste after stabilization is deemed suitable for on-site reuse, off-site reuse or disposal as non-hazardous waste.

### BACKGROUND OF THE INVENTION

The dangers of biological and human community exposure to elevated levels of contaminants such as heavy metals in groundwater and water supplies has been the subject of interest and regulatory control throughout the world for many years. Various countries such as Japan and Switzerland have recently established regulatory limits in addition to dissolved metals such as dissolved solids, salts and fluorides derived from wastes. The objective of these most recent regulations is to provide for control of all inorganic leaching potentials to landfill or open environments at which soluble wastes are disposed or reused.

Metal bearing materials and wastes, including but not limited to smelter and incinerator ashes, foundry and steel mill slags and ashes, wire insulation, auto shredder fluff, leaded paint and paint sand blast wastes, paint wastes, demolition debris, battery breaking waste and battery acid spillage soil sites, scrubber residues from brick furnace ash air pollution control devices such as cyclones, electrostatic precipitators and baghouse filter bags, may be deemed hazardous by the United States Environmental Protection Agency (U.S. EPA) pursuant to 40 C.F.R. Part 261, and other similar government regulations in countries such as Japan if containing leachable metals and/or soluble inorganics such as fluorides above allowable criteria. Any solid waste in the US can be defined as hazardous either because it is “listed” in 40 C.F.R., Part 261 Subpart D or because it exhibits one or more of the characteristics of a hazardous waste as defined at Part 261, Subpart C. These characteristics are: (1) ignitability, (2) corrosivity, (3) reactivity, and (4) toxicity as tested under the TCLP leaching procedure.

40 C.F.R., Part 261.24(a), contains a list of contaminants and their associated maximum allowable concentrations. If a contaminant, such as lead or arsenic, exceeds its maximum allowable concentration, when tested using the Toxicity Characteristic Leaching Procedure (TCLP) analysis as specified at 40 C.F.R. Part 261 Appendix 2, then the material is classified as hazardous. The TCLP test uses a dilute acetic acid either in deionized water (TCLP fluid 2) or in deionized water with a sodium hydroxide buffer (TCLP fluid 1). Both extracts attempt to simulate the leachate character from a decomposing trash landfill in which the hazardous waste being tested for is assumed to be disposed of in and thus subject to the acetic acid leaching condition. Waste containing leachable metals above criteria are currently classified as hazardous waste due to the toxicity characteristic, if the level of metals extracted in a TCLP analysis are above 0.2 to 100 milligrams per liter (mg/L) or parts per millions (ppm) depending on the metal. The TCLP test is designed to simulate a worst case leaching situation, that is leaching conditions which would typically be found in the interior of an actively degrading municipal landfill. Such landfills normally are slightly acidic with a pH of approximately 5±0.5.

Additionally, U.S. EPA land disposal restrictions prohibit the land disposal of solid wastes which leach in excess of maximum allowable concentrations upon performance of the TCLP analysis. The land disposal regulations require that hazardous wastes are treated until the heavy metals do not leach at UTS levels from the solid waste at levels above the maximum allowable concentrations prior to placement in a surface impoundment, waste pile, landfill or other land disposal unit as defined in 40 C.F.R. 260.10.

Leach test conditions thus include the conditions to which an ash, waste, material or soil is subjected during dilute acetic acid leaching (TCLP), buffered citric acid leaching (STLC), distilled water, synthetic rainwater or carbonated water leaching (US SPLP, Japanese and Swiss and SW-924). Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered acetic acid for 18 hours. The extract solution is made up from 5.7 ml of glacial acetic acid and 64.3 ml of 1.0 normal sodium hydroxide up to 1000 ml dilution with reagent water.

Suitable water leach tests include the Japanese leach test which tumbles 50 grams of composited waste sample in 500 ml of water for 6 hours held at pH 5.8 to 6.3, followed by centrifuge and 0.45 micron filtration prior to analyses. Another suitable distilled water CO₂ saturated method is the Swiss protocol using 100 grams of cemented waste at 1 cm³ in two (2) sequential water baths of 2000 ml. The concentration of heavy metals and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. The concentration of leached selenium is then analyzed by Inductively-Coupled Plasma (ICP) after filtration of a 100 ml aliquot from the tumbler through a 45 micron glass bead filter.

Of specific interest and concern regarding the present invention is the leaching of metals and fluoride under non-landfill conditions such as open industrial sites, waste storage cells, waste piles, waste monofills and under regulatory tests which attempt to simulate rainwater or surface water leaching for determination of hazardousness of any given soil, material or waste.

The present invention provides a method of reducing the leachability of metals while minimizing fluoride solubility under TCLP, SPLP, CALWET, rainwater and surface water leaching conditions as well as under regulatory water extraction test conditions as defined by waste control regulations in Japan, Switzerland, Germany, Sweden, The Netherlands and under American Nuclear Standards for sequential leaching of wastes by deionized water.

Unlike the present invention, prior art additives and mixtures have focused on reducing the leachability of only heavy metals such as Lead, Arsenic, Cadmium, Chromium under TCLP and landfill leaching conditions without consideration to fluorides solubility from either the material or stabilizers used to control metals.

U.S. Pat. No. 5,202,033 describes an in-situ method for decreasing Pb TCLP leaching from solid waste using a combination of solid waste additives and additional pH controlling agents from the source of phosphate, carbonate, and sulfates.

U.S. Pat. No. 5,037,479 discloses a method for treating highly hazardous waste containing unacceptable levels of TCLP Pb and Cd such as lead by mixing the solid waste with a buffering agent selected from the group consisting of magnesium oxide, magnesium hydroxide, reactive calcium carbonates and reactive magnesium carbonates with an additional agent which is either an acid or salt containing an anion from the group consisting of Triple Superphosphate (TSP), ammonium phosphate, diammonium phosphate, phosphoric acid, boric acid and metallic iron.

U.S. Pat. No. 4,889,640 discloses a method and mixture from treating TCLP hazardous lead by mixing the solid waste with an agent selected from the group consisting of reactive calcium carbonate, reactive magnesium carbonate and reactive calcium magnesium carbonate.

U.S. Pat. No. 4,652,381 discloses a process for treating industrial waste water contaminated with battery plant waste, such as sulfuric acid and heavy metals by treating the waste waster with calcium carbonate, calcium sulfate, calcium hydroxide to complete a separation of the heavy metals. However, this is not for use in a solid waste situation.

Unlike the present invention, however, none of the prior art solutions were designed to allow specifically for stabilization of metals bearing material or waste while also minimizing the solubility of fluoride from the stabilized material or waste.

### SUMMARY OF THE INVENTION

The present invention discloses a metal bearing material or waste stabilization method while minimizing fluoride solubility through contact of material or waste with stabilizing agents including phosphates, Portland cement, dolomitic lime, silicates, complexers and combinations thereof which are properly chosen to complement the material or waste constituency and desired material or waste handling characteristics. The stabilizing agents proven effective are provided in both in dry and wet chemical form, and thus can be contacted with material either prior to waste production such as in-duct prior to air pollution control and ash collection devices or after waste production in material collection devices or waste piles.

It is anticipated that the stabilizers can be used for both compliance actions such that generated wastes or materials from furnaces, incinerators and other facilities do not exceed hazardous waste criteria response where stabilizers are added to waste piles or storage vessels previously generated. The preferred method of application of stabilizers would be in-line within the property and facility generating the material, and thus allowed under international regulations as a totally enclosed, in-tank or exempt method of stabilization without the need for hazardous waste treatment and storage facility permit.

### DETAILED DESCRIPTION

Environmental regulations throughout the world such as those promulgated by the USEPA under RCRA and CERCLA require heavy metal bearing waste and material producers to manage such materials and wastes in a manner safe to the environment and protective of human health. In response to these regulations, environmental engineers and scientists have developed numerous means to control heavy metals, mostly through chemical applications which convert the solubility of the material and waste character to a low exposure form, thus passing leach tests and allowing the wastes to be either reused on-site or disposed at local landfills without further and more expensive control means such as hazardous waste disposal landfills or facilities designed to provide metals stabilization. The primary focus of scientists has been on lead, cadmium, chromium, arsenic and mercury, as these were and continue to be the most significant mass of metals contamination in soils. Materials such as paints, and cleanup site wastes such as battery acids and slag wastes from smelters are major lead sources. Recently, however, there exists an additional demand for control methods of other metals and soluble fractions such as fluoride from materials and wastes.

The present invention discloses a metal bearing material or waste stabilization method which minimizes fluoride leaching through contact of material or waste with stabilizing agents including phosphates, Portland cement, silicates, quicklime, complexers and combinations thereof. The stabilizing agents found effective are available in dry, slurry and wet chemical form, and thus can be contacted with material prior to waste generation such as in-duct prior to air pollution control and ash collection devices or after waste production in collection devices such as hoppers, dump valves, conveyors, dumpsters or waste piles.

It is anticipated that the stabilizers can be used for both compliance actions such that generated materials from furnaces, incinerators and other facilities do not exceed the hazardous waste criteria and also response actions where stabilizers are added to waste piles or storage vessels previously generated and now regulated as a hazardous waste predisposal. The preferred method of application of stabilizers would be in-line within the property and facility generating the selenium bearing material, and thus allowed without the need for hazardous waste treatment and storage facility permit(s).

The use of Portland cement, silicates, quicklime, phosphates, complexers and combinations with phosphates including but not limited to animal and fish bone calcium phosphates, wet process amber phosphoric acid, wet process green phosphoric acid, aluminum finishing Coproduct blends of phosphoric acid and sulfuric acid, technical grade phosphoric acid, monoammonia phosphate (MAP), diammonium phosphate (DAP), single superphosphate (SSP), triple superphosphate (TSP), hexametaphosphate (HMP), tetrapotassium polyphosphate, dicalcium phosphate, tricalcium phosphate, monocalcium phosphate, phosphate rock, pulverized forms of all above dry phosphates, and combinations thereof would, as an example, provide various amount of phosphate, cement, silicates, lime, complexers and or combination contact with material or waste. In certain cases such as use of amber and green acid, such acids embody sulfuric acid, vanadium, iron, aluminum and other complexing agents which could also provide for a single-step formation of complexed metal minerals. The phosphate, complexer, cement, silicate, lime and combination type, size, dose rate, contact duration, and application means could be engineered for each type of material or waste.

Although the exact stabilization formation molecule(s) are unknown at this time, it is expected that when metals comes into contact with the stabilizing agent(s), low water and low acid soluble compound(s) begin to form such as a mineral phosphate, twinned mineral, or precipitate through substitution or surface bonding, which is less soluble than the metal element or molecule originally in the material or waste. Specifically twinning of metals such as lead and arsenic into pyromorphite amorphous crystals most likely occurs by adding calcium phosphate(s) to the material or waste at standard temperature and pressure. It also remains possible that modifications to temperature and pressure may accelerate of assist formation of minerals, although such methods are not considered optimal for this application given the need to limit cost and provide for optional field based stabilizing operations that would be complicated by the need for pressure and temperature control devices and vessels. It has been observed that certain wastes and materials as well as ore-based phosphates have potential to leach fluoride, and that adjustments of phosphate source to a polyphosphate and/or bone phosphate, or modification of complexer and cement addition to phosphate source(s) can modify the soluble fluoride available from stabilized materials or wastes under water leaching tests . . . specifically the Japan leaching test.

In another method, material or waste is contacted with at least one phosphate in the presence of cement and at least one complexing agent to generate low metal and fluoride leaching material or waste. The complexing agent could include ferrous sulfate, iron, aluminum, calcium, chlorides, sulfates, vanadium, and various other agents which provide for or assist in formation of minerals. Use of phosphates in the presence of complex agents for metals mineral formations of lead bearing wastes is taught by U.S. Pat. No. 5,722,928 issued to Forrester.

Examples of suitable stabilizing agents include, but are not limited to, Portland cement, phosphate fertilizers, phosphate rock, pulverized phosphate rock, calcium orthophosphates, monocalcium phosphate, dicalcium phosphate, tricalcium phosphate, trisodium phosphates, calcium oxide (quicklime), dolomitic quicklime, silicates, sodium silicates, potassium silicates, natural phosphates, phosphoric acids, wet process green phosphoric acid, wet process amber phosphoric acid, black phosphoric acid, merchant grade phosphoric acid, aluminum finishing phosphoric and sulfuric acid solution, hypophosphoric acid, metaphosphoric acid, hexametaphosphate, tertrapotassium polyphosphate, polyphosphates, trisodium phosphates, pyrophosphoric acid, fishbone phosphate, animal bone phosphate, herring meal, animal bone meal, phosphorites, ferrous sulfate, and combinations thereof. Salts of phosphoric acid can be used and are preferably alkali metal salts such as, but not limited to, trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof.

The amounts of stabilizing agent used, according to the method of invention, depend on various factors including desired solubility reduction potential, desired mineral toxicity, and desired mineral formation relating to toxicological and site environmental control objectives. It has been found that an amount of certain stabilizing agents such as herring bone meal, equivalent to between about 1% weight of material or waste, 1% cement and 0.5% ferrous sulfate, is sufficient for stabilization of metals bearing soil to less than 0.01 ppm Pb, 0.01 ppm As and 0.80 ppm Fl under the Japan water leach test. However, the foregoing is not intended to preclude yet higher or lower usage of stabilizing agent or combinations if needed since it has been demonstrated that amounts greater than 2% by weight also work, but are more costly.

The examples below are merely illustrative of this invention and are not intended to limit it thereby in any way.

### EXAMPLE 1

In this example a contaminated soil containing Pb, As and Fl was stabilized with varying amounts of stabilizing agents including Triple Superphosphate (TSP), Hexametaphosphate (HMP), Tetrapotassium Polyphosphate (TPP), Trisodium Polyphosphate (TSPP), 32% Calcium Chloride solution (CC), 1/100 Sodium Silicate solution (NS), Herring Bone pulverized meal—calcium phosphate (HBM), Portland Cement type A/B (PC), and 20% Ferrous Sulfate solution (FSS) with 1 hour curing. Both stabilized and un-stabilized soils were subsequently tested under the Japan water leaching method for Pb, As and Fl.

TABLE 1

| Stabilizer Dose (%) | Fl-Pb-As (ppm) |
|---|---|
| Japan Limits | 0.80-0.01-0.01 |
| Soil Baseline | ND-0.41-0.008 (ND = <0.01) |
| TSP Baseline | 310-ND-ND |
| 0.7 TSP + 0.7 PC + 0.5 FS | 1.1-ND-0.008 |
| 2.0 HMP + 1.0 CC | 0.05-0.01-ND |
| 1.5 TSP + 1.5 PC + 1.0 CC + 10 NS | 0.70-ND-ND |
| 1 HBM | ND-0.25-0.005 |
| 1 HBM + 1 PC | 0.10-0.01-0.004 |
| 1 HBM + 1 PC + 0.5 FSS | 0.20-ND-0.003 |
| 0.7 TSPP + 0.7 PC | 0.30-ND-ND |
| 1.0 TSPP | ND-0.01-ND |
| 2.0 TSPP | ND-ND-ND |
| 1.0 TSPP + 0.5 NS | ND-ND-ND |
| 0.7 PC + 0.7 TSPP + 0.7 CC | 0.20-ND-ND |
| 0.7 TPP + 0.7 PC | ND-ND-ND |
| 2.0 HBM | ND-ND-ND |
| 1.0 HBM + 0.5 PC | 0.40-ND-ND |
| 0.7 PC + 0.7 TSP + 0.7 CC | 0.70-ND-ND |

The foregoing results in Table 1 readily established the operability of the present process to stabilize combinations of heavy metals while minimizing fluoride solubility, thus reducing leachability and bioavailability. Given the effectiveness of the stabilizing agents in causing stabilization as presented in the Table 1, it is believed that an amount of the stabilizing agents equivalent to less than 5% by weight of material or waste should be effective. It is also apparent from the Table 1 results that certain stabilizing agents and complexing blends are more effective for stabilization and fluoride solubility reduction.

While this invention has been particularly shown and described with reference to preferred embodiments thereof, it will be understood by those skilled in the art that various changes in form and details may be made therein without departing from the spirit and scope of the invention as defined by the appended claims.

I claim:

1. A method of reducing the solubility of heavy metal bearing material or waste while minimizing fluoride solubility, comprising contacting heavy bearing material or waste with at least one stabilizing agent in an amount effective in reducing the leaching of heavy metals and minimizing the solubility of fluorides from the material or waste to a level no more than allowed by regulatory criteria performed on the stabilized material or waste.

2. The method of claim 1, wherein the stabilizing agent is selected from the group consisting of phosphates, Portland cement, silicates, lime, phosphates and mineral complexing agent combinations, wet process amber phosphoric acid, wet process green phosphoric acid, coproduct phosphoric acid solution from aluminum polishing, technical grade phosphoric acid, hexametaphosphate, polyphosphate, calcium orthophosphate, superphosphates, triple superphosphates, phosphate fertilizers, phosphate rock, bone phosphate, fishbone phosphates, tetrapotassium polyphosphate, monocalcium phosphate, monoammonia phosphate, diammonium phosphate, dicalcium phosphate, tricalcium phosphate, trisodium phosphate, salts of phosphoric acid, and combinations thereof.

3. The method of claim 2, wherein the salts of phosphoric acid are alkali metal salts.

4. The method of claim 2, wherein the phosphate salt is a trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof.

5. The method of claim 2, wherein the phosphate and complexing agent as iron, calcium, chloride, or aluminum are supplied as one product including triple superphosphate, wet process phosphoric acid and combination fertilizer mixtures.

6. The method of claim 2, wherein the stabilizing complexing agents are selected from polymer, calcium chloride, sodium chloride, potassium chloride, vanadium, boron, iron, aluminum, sulfates, sulfides or combinations thereof.
